(19) United States
(12) Patent Application Publication
(10) Pub. No.: US 2001/0015018 A1
(43) Pub. Date: Aug. 23, 2001

(54) Stylus for nanotechnology and method for manufacturing the same

(76) Inventors: Philipp Niedermann, Peseux (CH); Urs Staufer, Neuchatel (CH)

Correspondence Address: Kurt D. Van Tassel, Van Tassel & Asssociates, P.O. Box 2928, Bellaire, TX, 77401-2928, US

(21) Appl. No.: 09/733,703

(22) Filed: Dec. 8, 2000

(30) Foreign Application Priority Data
Dec. 23, 1999 (EP) 99 811198.3

(51) Int. Cl. G01B 5/00

(52) U.S. Cl. 33/559

(57) ABSTRACT

The invention concerns a stylus intended for nanotechnology, including a monocrystalline silicon membrane (15), a beam (14) secured to the membrane by one end and a diamond tip (16), in the shape of a pyramid with three faces, arranged at the other end of the beam. The base of the pyramid forms an isosceles triangle having the axis of the beam as its axis of symmetry. Two of its faces are identical and arranged symmetrically with respect to said axis, the third face, which has the base of the isosceles triangle as its base, having said axis as its axis of symmetry.

The present invention concerns a stylus or probe intended for nanotechnology and a method for manufacturing the same.

A stylus of this type is generally formed of a tip of hard material arranged at the end of a beam or cantilever. This tip, the radius of which is typically 10 to 20 nm and which can be moved across sub-micrometric distances in three orthogonal directions, can be used in particular for nanoindentation, nanoscratching and AFM imagery (atomic force microscopy).

In the current state of the art, tips of this type, often called AFM tips, are most often made of silicon and more rarely of diamond. There also exist silicon tips covered with a diamond layer 100 nm thick, made by CVD (chemical vapour deposition).

Pyramidal tips with four diamond faces manufactured by moulding, have also been proposed recently (European Patent No. 0766 060 A1). Although these tips are very advantageous, the manufacturing thereof is quite complex. It is difficult, in fact, to join the four faces of the pyramid with sufficient precision in a reproductive manner.

The object of the present invention is to provide a stylus which does not have this drawback.

More precisely, the stylus according to the invention, which includes a monocrystalline silicon membrane, a beam secured to the membrane via one end and a diamond tip arranged at the other end of the beam, is characterised in that said tip has the shape of a pyramid with three faces.

The stylus according to the invention may also have the following features:

the base of the pyramid forms an isosceles triangle having the axis of the beam as its axis of symmetry;

two of the faces of the pyramid are identical and arranged symmetrically with respect to said axis of symmetry, the third face, which has the base of said isosceles triangle as its base, having said axis as its axis of symmetry.

According to an advantageous embodiment, the beam and the membrane are made of silicon and the diamond tip is secured in a cutting made in said beam. The beam and the membrane are then made in a single silicon block of {311} type cut or, more generally, having an orientation with a low symmetry. In an advantageous variant, the beam can be made of silicon of {100} type cut or, more generally, having an orientation of higher symmetry and the diamond tip, then anchored in the beam, is manufactured by moulding in a substrate of {311} type silicon or having an orientation with a low symmetry.

According to another advantageous embodiment, the beam is itself made of diamond and the tip forms an integral part of said beam.

The stylus is, preferably, secured to a rectangular frame delimiting a space inside which the beam and the membrane extend, the latter being secured to the uprights of the frame. Finally, a reinforcing frame is advantageously associated with the membrane and the rectangular frame.

The invention also concerns a method for manufacturing the stylus defined above.

According to an advantageous implementation, the method includes the following operations:

depositing at least one barrier layer on the top and bottom faces of a monocrystalline silicon substrate plate,

etching a cutting in the shape of an isosceles triangle in the top layer,

chemically etching the plate to obtain a pyramidal mould with three faces,

removing the top barrier layer,

depositing and etching on the top face of the plate a diamond layer forming a strip covering said mould, of the same axis as the axis of symmetry of said triangle,

etching in the bottom barrier layer a central cutting of the same axis as the axis of symmetry of said isosceles triangle, and

chemically etching the plate to remove the portion thereof which corresponds to said central cutting.

According to another advantageous implementation, the method includes the following operations:

depositing at least one barrier layer on the top and bottom faces of a monocrystalline silicon substrate plate,

etching a cutting in the shape of an isosceles triangle in the top layer,

chemically etching the plate to obtain a pyramidal mould with three faces the base of which has a contour corresponding to that of said cutting,

removing the top barrier layer,

depositing on the top face of the plate a diamond layer covering said mould,

chemically etching the plate from its bottom face to form a basin therein,

depositing a barrier layer on the top surface of the plate,

etching in said bottom barrier layer a central U-shaped cutting having the same axis as the axis of symmetry of said isosceles triangle, the base of which surrounds said diamond layer, and

chemically etching the plate, from its top face, to remove the portion thereof which corresponds to said central cutting.

Other advantages and features of the invention will become clear from the following description, made with reference to the annexed drawings in which:

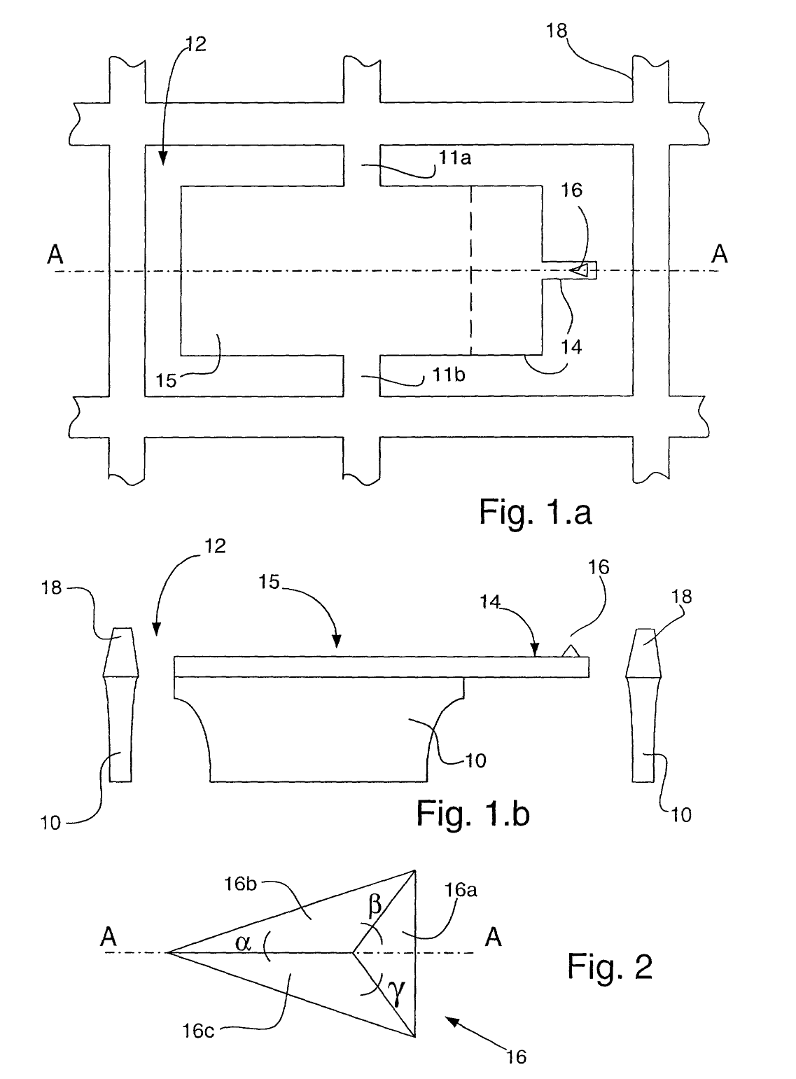

FIG. 1 shows a stylus according to the invention;

FIG. 2 shows the tip fitted to the stylus of FIG. 1;

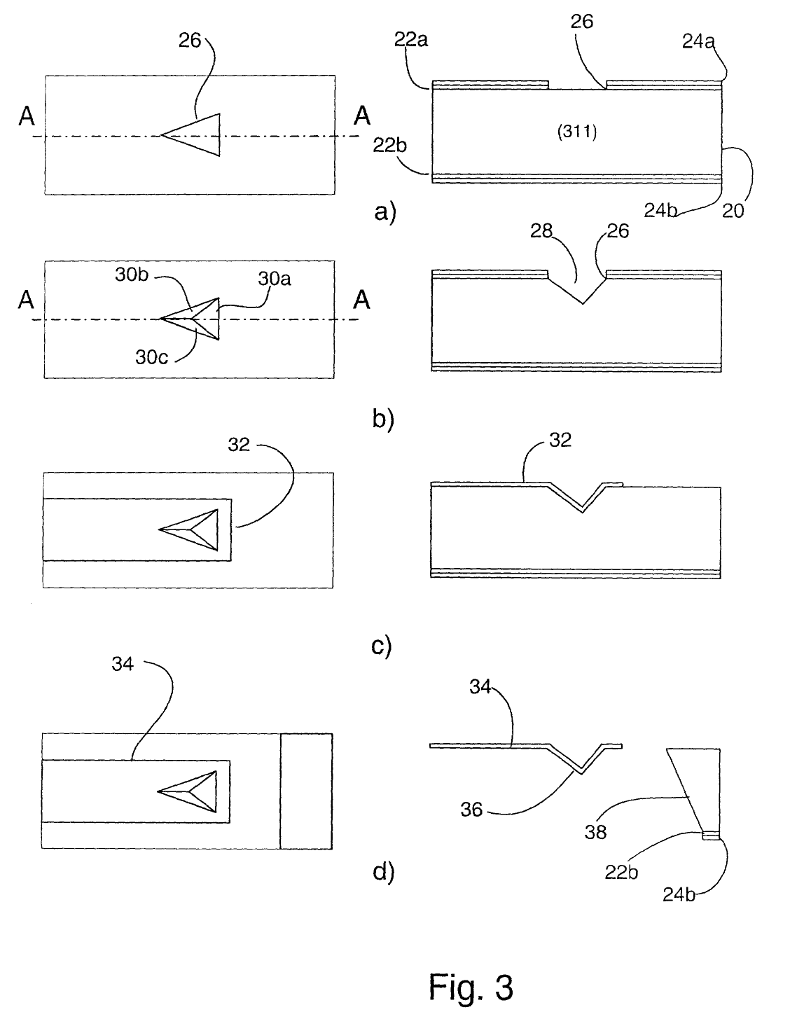

FIGS. 3 to 5 show the different manufacturing steps of such a stylus; and

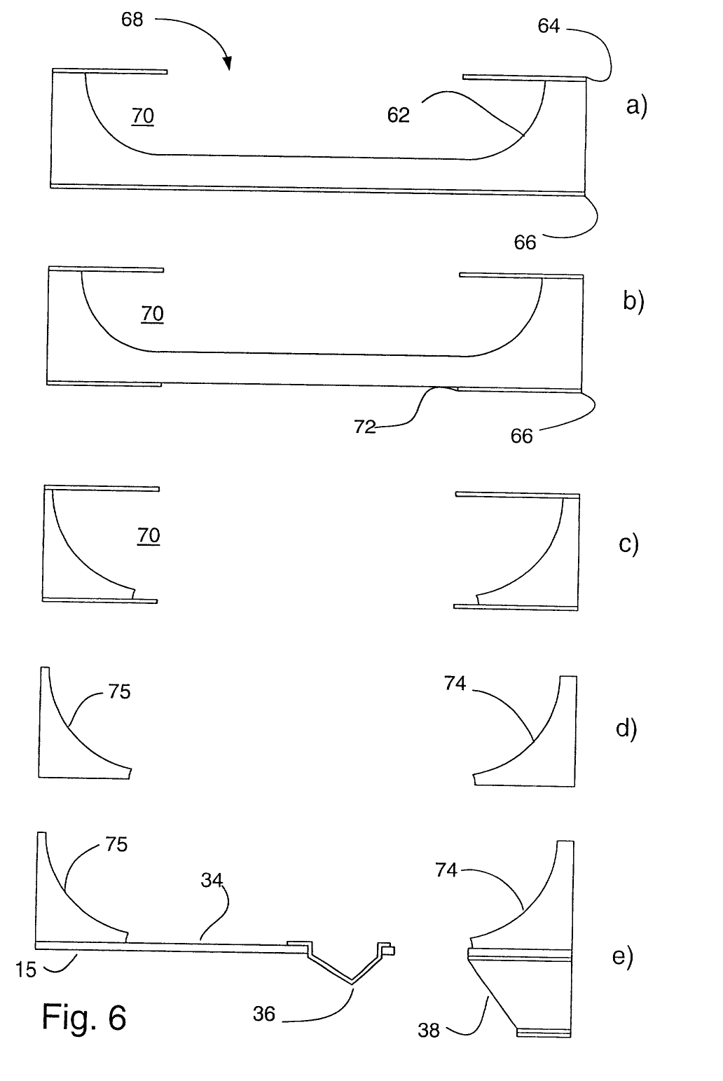

FIG. 6 illustrates the steps for mounting the stylus on a support.

The stylus of FIG. 1 is shown in the final manufacturing step still secured to its frame. As is seen in the top view 1.a and the cross-section 1.b (along A - A), the frame is formed of a monocrystalline silicon portion 18 and a glass portion 10. To this frame, which delimits a space 12, there is attached, via two arms 11.a and 11.b, the actual stylus, which includes a beam 14, at the tapered end of which there is a tip 16, and a membrane 15. As shown in FIG. 1.b, membrane 15 is reinforced by a glass support 10. Beam 14 and membrane 15 are, like frame 18, made of monocrystalline silicon, whereas tip 16 is made of diamond. The reinforcing glass may be a boron silicate glass, such as that known under the brand name Pyrex®. Although only a single stylus element is shown in FIG. 1, it will easily be understood that a plurality of such elements may simultaneously be made on a same silicon wafer or plate. The stylus can easily be separated from its frame by breaking attachments 11.a and 11.b using tweezers, for example, or any other appropriate means.

Tip 16 is a pyramid with a triangular base, i.e. it has a tetrahedron shape. Such a shape has an obvious advantage compared to the pyramids with a square base of the prior art, because, geometrically, the intersection of three planes necessarily defines a point, whereas it is much more difficult to get four planes to intersect at one point. Practice has demonstrated that by making a tip of pyramidal shape with a triangular base, it radius of curvature at the top is less than 20 nm, a value which it is extremely difficult to achieve with a pyramidal shaped tip with a square base.

Typically, such a stylus can be made with the following dimensions:

beam: length 300 - 500 μm; width 50 - 100 μm; thickness 2 - 20 μm;

tip: height 10 - 15 μm;

stylus (without the frame): 2×4×0.5 mm³.

As FIG. 2 shows, diamond tip 16, shown seen from below on a very enlarged scale, has a base in the shape of a generally isosceles triangle (see below for a more detailed explanation) having axis M as its axis of symmetry and the tip of which is directed towards the end of beam 14 which is not free. It includes three triangular faces 16a, 16b and 16c. Triangular face 16a, which has the base of the generally isosceles triangle as its base, is itself isosceles. The two other triangular faces 16b and 16c, which are symmetrical with respect to axis AA, are generally identical.

As will appear hereinafter, tip 16 is formed of a diamond layer deposited in a mould formed by chemically etching a silicon substrate. The relative orientation of the three faces of the pyramid is thus characteristic of the orientation of this material. In the example described hereinafter, which refers to a silicon plate having a {311} type cut, the angle a between faces 16b and 16c is equal to 109.5°, the angle β between face 16a and face 16b is equal to 70.5° and the angle γ between face 16a and face 16c is also equal to 70.5°.

The plane selected for the section of the substrate or base plate can be modified to a great extent. It need only be arranged so that three {111} type planes form a tetrahedron with it. Thus, one can move away from the orientation {311} indicated hereinbefore, which will have the effect of deforming the tetrahedron tip with respect to its symmetrical shape as described previously. In any case, however, when silicon is used, the angles between the faces remain the same. Only the ratio between the height of the tip and the surface of the base changes. Besides silicon, which remains the preferred material, it is possible to envisage using other materials, such as quartz or, gallium arsenide (GaAs).

According to a first implementation of the invention, a stylus is made wherein beam 14 and tip 16 are both made of diamond. The four main steps of the method are shown in FIG. 3, where only the tapered end of the stylus and the part of the frame which faces it are shown, identified by the letters a, b, c and d. In this Figure, the part on the left shows a portion of the stylus seen from above, whereas the part on the right shows it in cross-section.

FIG. 3a shows a substrate 20, of longitudinal axis AA, made of monocrystalline silicon, formed from an ingot sawed along a {311} type plane. This substrate carries, on each of its faces and superposed, a barrier layer of silicon dioxide (SiO₂) 22 and a barrier layer of silicon nitride (Si₃N₄) 24, the layers arranged on the top face of substrate 20 being identified by the letter a and those located on the bottom face by the letter b. The thickness of these layers is typically several hundred nanometers (nm).

Top layers 22a and 24a are, first of all, etched according to a cutting 26, in the shape of an isosceles triangle of axis of symmetry AA, corresponding to the base of tip 16 to be made, by the usual photolithographic and etching techniques.

The second step of the method, illustrated by FIG. 3b, consists in etching the substrate by means of a potassium solution (KOH) so as to obtain a tetrahedron mould 18 which includes a triangular base of the same shape as cutting 26 and three faces 30a, 30b and 30c. Faces 30b and 30c are arranged symmetrically with respect to line AA which passes along their common edge and cuts face 30a at its middle. This mould is defined by the intersection of three planes of {111} type.

Top layers 22a and 24a are then removed, so that the silicon becomes apparent over the entire top surface of substrate 20. This elimination may be carried out, conventionally, by plasma etching, or by chemical etching using an HF solution.

The next step, shown in FIG. 3c, consists in forming on the top layer of substrate 20 a diamond layer 32 intended to form the beam of the stylus fitted with its tip. To do this, a diamond layer is deposited over the entire substrate as well as in mould 28; then, this diamond layer is structured, by photolithography and RIE (Reactive Ion Etching) in an oxygen plasma, to correspond to the shape of the beam. Diamond layer 32 is obtained by growing the diamond, for example according to the method disclosed in European Patent No. 0766 060, from a nucleation layer, formed of diamond microparticles.

Finally, as illustrated by FIG. 3d, a beam 34 provided with its tip 36, both made of diamond, is obtained via the following operations:

protecting the top face of substrate 20 by means of a barrier layer of silicon dioxide (SiO2);

forming, by photolithography and etching, in bottom layers 22b and 24b, a rectangular cutting, of longitudinal axis AA;

etching the silicon with KOH to leave only one rectangular frame 38 and beam 34 provided with its tip 36;

removing the protective layer covering the top face of substrate 20.

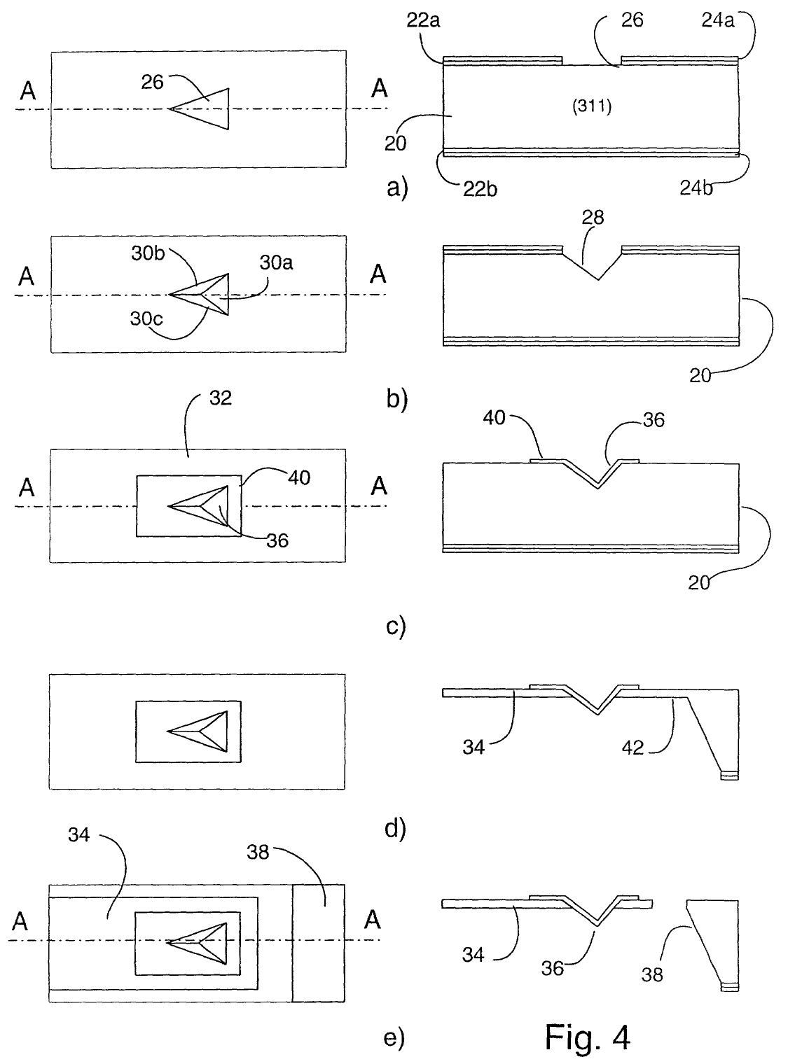

The method described with reference to FIG. 4, in which the elements common to the embodiment of FIG. 3 are designated by the same reference numbers, allows the manufacture of a stylus whose beam 34 is made of silicon, the diamond tip 36 being secured into its end.

The first and second steps, shown at a and b, are identical to those of the method of FIG. 3. One again finds substrate 20 made of silicon of {311} cut, layers 22 and 24, cutting 26 and mould 28.

In the next step, shown in FIG. 4c, the diamond layer 32 is made according to the previously indicated method. Its surface is however considerably reduced, being limited to a rectangle which surrounds mould 28 and thus forms, a base plate 40, the surface of which is substantially equal to two times that of mould 26 and which is intended to ensure that the diamond tip is securely fixed.

During the step shown in FIG. 4d, the same operations as those described with reference to FIG. 3d are performed, the etching of the silicon being, however, incomplete, so as to obtain a basin the bottom of which is formed by a membrane 42.

As illustrated in FIG. 4e, the top face of substrate 20 and the bottom face of membrane 42 as well as the inner walls of frame 38 are then protected by a barrier layer which is not susceptible to KOH. On the top face, this layer is etched locally, over its entire thickness, by photolithography, to define the shape of the beam, of axis AA, which surrounds base plate 40. Membrane 42 is then etched with KOH, so as to release beam 34. The structure thereby obtained is thus identical to that illustrated in FIG. 3d but with a diamond tip 36 secured in the free end of silicon beam 34.

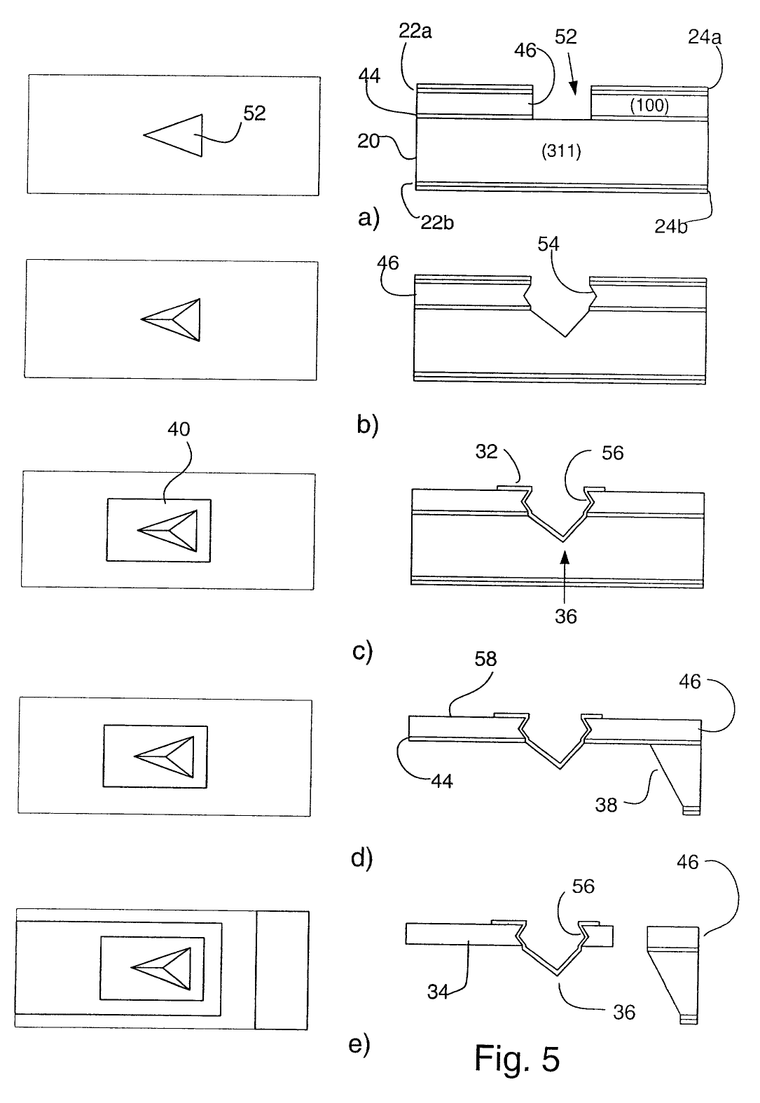

With the method described with reference to FIG. 5, in which the elements common to the preceding embodiments are designated by the same reference numbers, the stylus obtained includes a diamond tip 36 anchored in the end of silicon beam 34. Such a method allows a precise and uniform thickness of the stylus beam to be guaranteed.

According to this method, it is necessary to use an SOI (Silicon on Insulator) type assembly. Such an assembly is, in fact, formed of two silicon plates 20 and 46 assembled to each other via an insulating layer (SiO₂). In the example shown, bottom plate 20 has an orientation of {311} type whereas top plate 46 has an orientation of {100} type. This top plate has been thinned to a thickness which must correspond to that of the stylus beam. The top and bottom faces of the SOI assembly are coated with a first (22a, 22b) insulating layer of oxide SiO₂, then a second (24a, 24b) insulating layer of nitride Si₃N₄. During the first step, illustrated by FIG. 5a, a triangular cutting 52, of the same shape as that of cutting 26, is made by photolithography, in the same way as described with reference to FIG. 3, over the entire stack arranged on plate 20, i.e. through layers 24a, 22a, 46 and 44. At the bottom of this cutting, {311} type silicon plate 20 is bare.

During the next operation, shown in FIG. 5b, the silicon of plate 20 is etched by means of KOH in a similar way to that described hereinabove. In this case, the KOH also acts on layer 46 of {100} type silicon, causing lateral etching which forms a groove 054.

The step shown in FIG. 5c is entirely comparable to that described with reference to FIG. 4c, with the creation of a diamond layer 32 which forms tip 36 and base plate 40. It is to be stressed, however, that this layer penetrates groove 54 to form an anchoring ring 56, which considerably reinforces the connection between beam 34 and tip 36.

During the step illustrated by FIG. 5d, similar to the step of FIG. 4d, the silicon of plate 20 is removed in the central portion, over the entire thickness, to define frame 38; oxide layer 44 forming an etching blocking layer. There then remains a membrane 58 formed of layers 44 and 46.

In the step corresponding to FIG. 5e, one again finds all the operations described with reference to FIG. 4e but, in addition, the removal of layer 44 of SiO₂. After this operation, the silicon of layer 46 is etched to form beam 34. In this case, the precision of the thickness of the silicon beam is better than in the case of the method described with reference to FIG. 4, since it is easier to control this dimension.

In the above three embodiment examples, cuttings 26 and 52 are obtained from masks of triangular shape. Such a geometry provides a maximum silicon surface in contact with the KOH. Other shapes may also be envisaged without the shape of the mould being thereby modified, the latter being defined only by the {111} type planes of the silicon structure.

Until now only the way in which an assembly including a beam, a tip and a frame is formed has been described. Since several of these assemblies are manufactured simultaneously on a same plate, it is then necessary to separate them from each other. For this purpose, during the manufacturing process, grooves may be arranged between the frames, the latter being connected to each other by means of bridges. The separation then occurs simply by breaking the bridges.

In order to be able to use the beam provided with its tip in optimum conditions, it is desirable for it to be secured to a rigid base. However, frame 38 is extremely light. In order to overcome this drawback, the silicon frame, as well as the stylus membranes are secured to a Pyrex support, in accordance with the method shown schematically in FIG. 6.

As FIG. 6a shows, the support is formed in a Pyrex plate 62, approximately 500 μm thick, the top and bottom faces of which respectively carry monocrystalline silicon layers 64 and 66. Top layer 64 is treated by photolithography and chemically etched, so as to open a central cutting 68. Pyrex plate 62 is then etched by means of fluorohydric acid (HF) so as to obtain a basin 70 the edges of which are rounded and the depth of which is approximately equal to half of the thickness of plate 62. The rounding of the edges is due to the fact that the etching of the Pyrex is isotropic. The plate is shown in this state in FIG. 6a.

FIG. 6b shows that afterwards, a cutting 72, of the same dimensions as cutting 68 is formed, by photolithography, in bottom layer 66. The plate is then again etched by means of HF. As FIG. 6c shows, the Pyrex glass is, this time, removed from the two faces, so that the depth of basin 70 increases. A basin is also made from the other face, until the wall which separates the two basins is pierced.

Finally, as FIG. 6d shows, the residue of layers 64 and 66 is eliminated by means of KOH.

The plate thereby obtained includes frames 74, intended to correspond to those of the stylus elements of one of the preceding methods, and reinforcements 75 intended to reinforce the membranes of these same stylus elements. The Pyrex plate is then secured, by anodic bonding, to the silicon substrate in which the stylus elements have been made.

FIG. 6e shows finally a device formed of an assembly obtained according to the method described with reference to FIG. 5, with a membrane 15, a beam 34, a tip 36 and a frame 38; frame 38 as well as membrane 15 being reinforced by a thickness of Pyrex (74.75). The description of the present invention was made with reference to cuts of monocrystalline silicon of {311} and {100} types. However, more generally, substrates having orientations of low symmetry and orientations of high symmetry may also be used.

1. Stylus intended for nanotechnology, including a monocrystalline silicon membrane (15, 42), a beam (14, 34) secured to said membrane by one end and a diamond tip (16, 36) arranged at the other end of said beam, characterised in that said tip has the shape of a pyramid with three faces.

2. Stylus according to claim 1, characterised in that the base of the pyramid forms an isosceles triangle having the axis of the beam as its axis of symmetry.

3. Stylus according to claim 2, characterised in that two of the faces of the pyramid are identical and arranged symmetrically with respect to said axis of symmetry, the third face, which has the base of said isosceles triangle as its base, having said axis as its axis of symmetry.

4. Stylus according to any of claims 1 to 3, characterised in that the stylus is itself made of diamond and in that the tip forms an integral part of said beam.

5. Stylus according to any of claims 1 to 3, characterised in that the beam is made of silicon and in that the diamond tip is secured in a cutting made in said beam.

6. Stylus according to claim 5, characterised in that the beam and the membrane are made in a single block of monocrystalline silicon.

7. Stylus according to claim 6, characterised in that silicon has a cut of low symmetry.

8. Stylus according to claim 7, characterised in that said cut is of {311} type.

9. Stylus according to any of claims 1 to 8, characterised in that it is secured to a rectangular frame delimiting a space (12) inside which the beam and the membrane extend, the latter being secured to the uprights of the beam.

10. Stylus according to claim 9, characterised in that it further includes a reinforcing frame associated with said rectangular frame and with said membrane.

11. Method for manufacturing a stylus according to claim 1, characterised in that it includes the following operations:
depositing at least one barrier layer on the top and bottom faces of a monocrystalline silicon substrate plate,
etching a cutting in the shape of an isosceles triangle in the top layer,
chemically etching the plate to obtain a pyramidal mould with three faces, the base of which has a contour corresponding to that of the cutting,
removing the top barrier layer,
depositing and etching on the top face of the plate a diamond layer forming a strip covering said mould, of the same axis as the axis of symmetry of said triangle,
etching in the bottom barrier layer a central cutting of the same axis as the axis of symmetry of said isosceles triangle, and
chemically etching the plate to remove the portion thereof which corresponds to said central cutting.

12. Method for manufacturing a stylus according to claim 1, characterised in that it includes the following operations:
depositing at least one barrier layer on the top and bottom faces of a monocrystalline silicon substrate plate,
etching a cutting in the shape of an isosceles triangle in the barrier layer,
chemically etching the plate to obtain a pyramidal mould with three faces the base of which has a contour corresponding to that of said cutting,
removing the top barrier layer,
depositing on the top face of the plate a diamond layer covering said mould,
chemically etching the plate from its bottom face to form a basin therein,
etching in said barrier layer a central U-shaped cutting of the same axis as the axis of symmetry of said isosceles triangle, the base of which surrounds said diamond layer, and
chemically etching the plate to remove the portion thereof which corresponds to said central cutting.
